(19) United States
(12) Patent Application Publication
(10) Pub. No.: US 2013/0164038 A1
(43) Pub. Date: Jun. 27, 2013

(54) DEVELOPING MEMBER AND PRODUCTION METHOD THEREFOR, AND ELECTROPHOTOGRAPHIC IMAGE FORMING APPARATUS

(71) Applicant: CANON KABUSHIKI KAISHA, Tokyo (JP)

(72) Inventors: Takashi Kusaba, Suntou-gun (JP); Shohei Urushihara, Suntou-gun (JP); Ryo Sugiyama, Mishima-shi (JP); Masashi Uno, Mishima-shi (JP)

(73) Assignee: CANON KABUSHIKI KAISHA, Tokyo (JP)

(21) Appl. No.: 13/769,237

(22) Filed: Feb. 15, 2013

Related U.S. Application Data
(63) Continuation of application No. PCT/JP2012/004918, filed on Aug. 2, 2012.

(30) Foreign Application Priority Data
Aug. 25, 2011 (JP) 2011-183826

(51) Int. Cl. C09D 183/04; C09D 175/04; G03G 15/08

(52) U.S. Cl. CPC C09D 183/04; G03G 15/08; C09D 175/04
USPC 399/252; 428/447; 428/425.5; 427/387

(57) ABSTRACT

Provided is a developing member capable of suppressing occurrence of compression set. The developing member comprises a substrate; an elastic layer provided on the substrate; and a coating layer provided on the elastic layer, wherein the elastic layer contains a cured substance of a mixture containing the following (A) to (D): (A) organopolysiloxane having two or more vinyl groups bonded to a silicon atom in one molecule and having a viscosity at 25° C. of 10 Pa·s or more and 100 Pa·s or less; (B) organopolysiloxane including constituent units of SiO_{4/2} unit and R¹R²R³SiO_{1/2} unit, where R¹, R², and R³ each represent one of a methyl group and a vinyl group, and having two or more vinyl groups bonded to a silicon atom in one molecule; (C) organohydrogenpolysiloxane having two or more hydrogen atoms bonded to a silicon atom in one molecule; and (D) carbon black.

### CROSS-REFERENCE TO RELATED APPLICATIONS

This application is a continuation of International Application No. PCT/JP2012/004918, filed Aug. 2, 2012, which is claims the benefit of Japanese Patent Application No. 2011-183826, filed Aug. 25, 2011.

### BACKGROUND OF THE INVENTION

1. Field of the Invention

The present invention relates to a developing member used in an electrophotographic image forming apparatus using an electrophotographic system such as a copier, a laser beam printer, a facsimile, and a printer, and an electrophotographic image forming apparatus.

2. Description of the Related Art

In recent electrophotographic apparatuses, apparatuses each using a non-magnetic one-component contact development system have come to be used in most cases along with the reduction in size of a main body and colorization. The non-magnetic one-component contact development system is the following method involving using non-magnetic one-component toner. The toner is supplied onto a developing member by a toner supplying roller that is in contact with a developing roller, and the toner is charged by the friction between a developing blade that is a toner regulating member and the toner, and the friction between the developing member and the toner. Concurrently, the toner is thinly and uniformly applied onto the developing member with the developing blade. As a result of the rotation of the developing roller, the toner is conveyed to a developing region where the developing member and a photosensitive drum face each other in contact, and an electrostatic latent image on the photosensitive drum is developed and visualized as a toner image.

As described above, the developing member needs to have low hardness so as to rotate while holding a predetermined contact region (nip width) with respect to the developing blade and the photosensitive drum. On the other hand, the developing member and the developing blade are constantly in contact. Therefore, in the case where an image forming apparatus is left without printing for a long period of time, the developing blade comes into pressure-contact with the same portion of the developing roller, which may cause deformation (compression set) that is not recovered easily in a part of the developing member.

Then, in the case of providing such a developing member for forming an electrophotographic image, the thickness of a toner layer to be formed on the developing member partially has unevenness. As a result, defects such as unevenness and streaks may occur at a position of the electrophotographic image corresponding to the portion of the developing member in which the compression set occurs. Therefore, there is a demand for a developing member in which compression set does not occur easily.

In order to fulfill the demand, there has been proposed a silicone rubber composition and a developing roller in which an attempt is made to alleviate permanent deformation by adding an inorganic filler having particular physical properties (Japanese Patent Application Laid-Open No. 2008-074912). Further, there has been proposed a silicone rubber composition for a developing roller in which an attempt is made to alleviate permanent deformation by defining a content of low-molecular polysiloxane (Japanese Patent Application Laid-Open No. 2008-074913). Further, there has been proposed an elastic body having a cured substance of a polysiloxane mixture having a resinous organosiloxane that contains a resin segment containing at least one of a tetrafunctional constituent unit and a trifunctional constituent unit, and a bifunctional oil segment (Japanese Patent Application Laid-Open No. H05-214250).

### SUMMARY OF THE INVENTION

However, in recent years, the colorization of an image forming apparatus has advanced further, and the output of graphic patterns except character images called text images is increasing. Therefore, defects caused by the compression set of the developing roller have come to be visually recognized more easily on an image.

Then, according to the study by the inventors of the present invention, there is still room for improving the developing roller using a silicone rubber mixture according to the above-mentioned Patent Literatures 1 and 3 with respect to the above-mentioned problem.

On the other hand, by enhancing the hardness of an elastic layer of the developing member, the occurrence of compression set can be inhibited. However, the developing member with high hardness accelerates the wear of the surface of the photosensitive drum.

In view of the foregoing, the present invention is directed to providing a developing member to which a compression set hardly occur although the developing member is soft, and a production method of the developing member.

Further, the present invention is directed to providing an electrophotographic image forming apparatus capable of stably providing a high-quality electrophotographic image.

According to one aspect of the present invention, there is provided a developing member, comprising: a substrate; an elastic layer provided on the substrate; and a coating layer provided on the elastic layer, wherein the elastic layer contains a cured substance of a mixture containing the following (A) to (D):

(A) organopolysiloxane having two or more vinyl groups bonded to a silicon atom in one molecule and having a viscosity at 25° C. of 10 Pa·s or more and 100 Pa·s or less;
(B) organopolysiloxane including constituent units of SiO_{4/2} unit and R¹R²R³SiO_{1/2} unit, where R¹, R², and R³ each represent one of a methyl group and a vinyl group, and having two or more vinyl groups bonded to a silicon atom in one molecule;
(C) organohydrogenpolysiloxane having two or more hydrogen atoms bonded to a silicon atom in one molecule; and
(D) carbon black.

According to another aspect of the present invention, there is provided a method of producing a developing member comprising: a substrate; an elastic layer provided on the substrate; and a coating layer provided on the elastic layer, the method comprising a step of curing a mixture containing the following (A) to (D) to form the elastic layer:

(A) organopolysiloxane having two or more vinyl groups bonded to a silicon atom in one molecule and having a viscosity at 25° C. of 10 Pa·s or more and 100 Pa·s or less;
(B) organopolysiloxane including constituent units of SiO_{4/2} unit and R¹R²R³SiO_{1/2} unit, where R¹, R², and R³ each represent one of a methyl group and a vinyl group, and having two or more vinyl groups bonded to a silicon atom in one molecule;
(C) organohydrogenpolysiloxane having two or more hydrogen atoms bonded to a silicon atom in one molecule; and
(D) carbon black.

According to further aspect of the present invention, there is provided an image forming apparatus, comprising: a photosensitive drum; and a developing unit for developing an electrostatic latent image formed on a surface of the photosensitive drum with toner, wherein the developing unit comprises a developing roller arranged in contact with the photosensitive drum, and the developing roller comprises the above-described developing member.

According to the present invention, there is provided the developing member in which compression set does not occur easily despite the softness of the member. Further, according to the present invention, provided is the electrophotographic image forming apparatus capable of stably providing a high-quality electrophotographic image.

Further features of the present invention will become apparent from the following description of exemplary embodiments with reference to the attached drawings.

### BRIEF DESCRIPTION OF THE DRAWINGS

FIG. 1A is a schematic view illustrating an example of a roller-shaped developing member according to the present invention and is a schematic cross-sectional view parallel to a longitudinal direction of a mandrel.

FIG. 1B is a schematic view illustrating an example of a roller-shaped developing member according to the present invention and is a schematic cross-sectional view perpendicular to the longitudinal direction of the mandrel.

FIG. 2 is a schematic structural view illustrating an example of an electrophotographic image forming apparatus to which the developing member according to the present invention is applied.

FIG. 3 is a schematic view illustrating an example of a dip painting machine used for forming a coating layer of the developing member according to the present invention.

FIG. 4 is a schematic view of a device for measuring an electric resistance of the developing roller.

FIG. 5 is a schematic cross-sectional view of a measurement device for measuring an outer diameter size of the developing roller.

### DESCRIPTION OF THE EMBODIMENTS

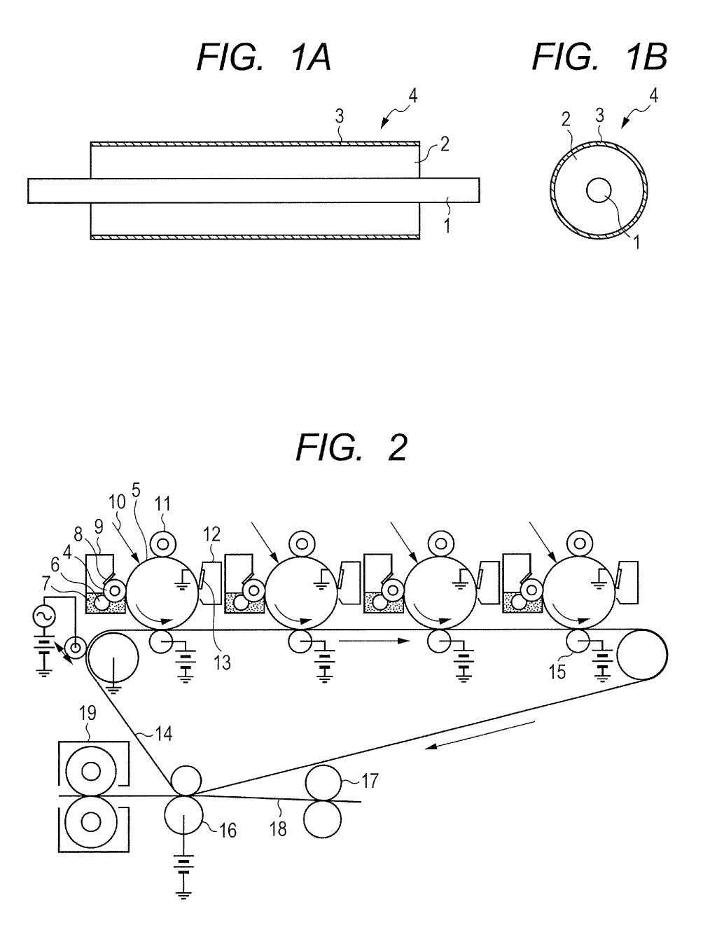

The present invention is hereinafter described in detail. FIGS. 1A and 1B are schematic views each illustrating an example of a roller-shaped developing member, i.e., a developing roller according to the present invention. FIGS. 1A and 1B are a schematic cross-sectional view parallel to a longitudinal direction of a mandrel that is a substrate, and a schematic cross-sectional view perpendicular to the longitudinal direction of the mandrel, respectively. The developing roller according to the present invention has a configuration in which an elastic layer 2 is provided on a mandrel 1 and a coating layer 3 is provided on the elastic layer 2.

<Elastic Layer>

The elastic layer contains an electro-conductive silicone rubber obtained by curing a mixture containing the following (A) to (D):

(A) organopolysiloxane having two or more vinyl groups bonded to a silicon atom in one molecule and having a viscosity at 25° C. of 10 Pa·s or more and 100 Pa·s or less;
(B) organopolysiloxane including constituent units of SiO_{4/2} unit and R¹R²R³SiO_{1/2} unit, where R¹, R², and R³ each represent a methyl group or a vinyl group, and having two or more vinyl groups bonded to a silicon atom in one molecule;
(C) organohydrogenpolysiloxane having two or more hydrogen atoms bonded to a silicon atom in one molecule; and
(D) carbon black.

The organopolysiloxane having two or more vinyl groups bonded to a silicon atom in one molecule and having a viscosity at 25° C. of 10 Pa·s or more and 100 Pa·s or less described in (A) is a base polymer of the electro-conductive silicone rubber forming the elastic layer. As the vinyl group-containing organopolysiloxane, those represented by the following average composition formula (1) can be used.

RₐSiO_{(4-a)/2} (1)

In the formula (1), R represents a monovalent hydrocarbon group having 1 to 10 carbon atoms of the same kind or different kinds, preferably unsubstituted or substituted monovalent hydrocarbon group having 1 to 8 carbon atoms. And a represents a positive number in the range of 1.5 to 2.8, preferably 1.8 to 2.5, more preferably 1.95 to 2.02.

In this case, examples of the unsubstituted or substituted monovalent hydrocarbon group represented by R and bonded to the silicon atom include: an alkyl group such as a methyl group, an ethyl group, a propyl group, an isopropyl group, a butyl group, a isobutyl group, a tert-butyl group, a pentyl group, a neopentyl group, a hexyl group, a cyclohexyl group, an octyl group, a nonyl group, and a decyl group; an aryl group such as a phenyl group, a tolyl group, a xylyl group, and a naphthyl group; an aralkyl group such as a benzyl group, a phenylethyl group, and a phenylpropyl group; an alkenyl group such as a vinyl group, an allyl group, a propenyl group, an isopropenyl group, a butenyl group, a hexenyl group, a cyclohexenyl group, and an octenyl group; and a substituted group such as a chloromethyl group, a chloropropyl group, a bromoethyl group, a trifluoropropyl group, and a cyanoethyl group, which are obtained by substituting a part or all of hydrogen atoms in each of the above groups with a halogen atom such as fluorine, bromine, and chlorine, or a cyano group, in which 90% or more of the total number of R preferably represent a methyl group, and at least 2 of R need to represent a vinyl group.

It is necessary that the viscosity at 25° C. of the organopolysiloxane described in (A) be 10 Pa·s or more and 100 Pa·s or less. When the viscosity at 25° C. is 10 Pa·s or more, the flexibility of the developing roller can be ensured, and thus, the viscosity at 25° C. is preferably 30 Pa·s or more. On the other hand, when the viscosity at 25° C. is 100 Pa·s or less, the compression set can be controlled, and thus, the viscosity at 25° C. is preferably 70 Pa·s or less.

The organopolysiloxane described in (A) may be obtained by a known method. A general production method for the organopolysiloxane is, for example, a method involving performing an equilibration reaction between an organocyclopolysiloxane such as dimethylcyclopolysiloxane and methylvinylcyclopolysiloxane, and a hexaorganodisiloxane such as hexamethyldisiloxane and 1,3-divinyl-1,1,3,3-tetramethyldisiloxane in the presence of an alkali catalyst or an acid catalyst.

The organopolysiloxane described in (B) is a component for improving the compression set of the elastic layer containing a cured substance of a mixture containing the above-mentioned (A) to (D).

In order to improve the compression set of the elastic layer, it is necessary that the elastic layer contains an elastic material which restores to an original molecular structure immediately after an external force is removed even when the elastic layer is deformed with the external force. The inventors of the present invention have considered that an elastic material having such characteristics only needs to have a structure having high stiffness in the molecule thereof. Then, the inventors of the present invention have found that it is effective to use the organopolysiloxane described in (B) represented by the following average composition formula (2) as one of the materials for the cured substance constituting the elastic layer for achieving the above-mentioned object.

(R¹R²R³SiO_{1/2})ₓ(SiO_{4/2})_{1.0} (2)

The organopolysiloxane described in (B) includes constituent units of SiO_{4/2} unit and R¹R²R³SiO_{1/2} unit, where R¹, R², and R³ each represent one of a methyl group and a vinyl group, and has two or more vinyl groups bonded to a silicon atom in one molecule. The above-mentioned X is larger than 0 and smaller than 4.0. The organopolysiloxane described in (B) has an SiO_{4/2} unit and does not have an SiO_{2/2} unit called an oil segment, and hence, has a structure with high stiffness as a molecule.

It is considered that, an elastic body contains a molecule having such structure with high stiffness, and hence, the elastic body can restore to an original molecular structure immediately after an external force is removed even when the elastic body is deformed with the external force. It is presumed that, for the above-mentioned reason, the occurrence of the compression set can be controlled.

When the added amount of the organopolysiloxane described in (B) is 2 parts by mass or more and 10 parts by mass or less with respect to 100 parts by mass of the organopolysiloxane described in (A), and the above-mentioned X is 0.5 or more and 2.0 or less, an elastic layer satisfying both the flexibility and the effect of controlling the compression set at a higher level can be obtained.

The organopolysiloxane described in (B) can be obtained by the known method. For example, the organopolysiloxane described in (B) can be obtained easily by mixing R¹R²R³SiCl and SiCl₄ in an appropriate molar ratio and subjecting the mixture to co-hydrolytic condensation.

The organohydrogenpolysiloxane described in (C) is a so-called cross-linking agent, which has two or more hydrogen atoms bonded to a silicon atom in one molecule. The hydrogen atoms bonded to a silicon atom in a molecule are cross-linked by a hydrosilylation reaction with vinyl groups bonded to silicon atoms in the organopolysiloxane described in (A) and the organopolysiloxane described in (B), and function as a cross-linking agent for curing a composition.

Specific examples of the organohydrogenpolysiloxane described in (C) include both-terminals-trimethylsiloxy-methylhydrogen siloxane, both-terminals-trimethylsiloxy-methylhydrogen siloxane-dimethylsiloxane copolymer, and both-terminals-dimethylhydrogen siloxy-methylhydrogen siloxane-dimethylsiloxane copolymer. As the molecular structure of the organohydrogenpolysiloxane described in (C), a straight-chain structure, a branched structure, or an circular structure, or the like can be used without any particular limit. Further, it is preferred that the average molecular weight of the organohydrogenpolysiloxane described in (C) be in the range of 300 to 10,000.

Regarding the added amount of the organohydrogenpolysiloxane described in (C), it is preferred that the amount of the hydrogen atoms bonded to a silicon atom in the organohydrogenpolysiloxane described in (C) be 0.8 mol or more and 3.0 mols or less with respect to a total one mole of the vinyl groups in the organopolysiloxane described in (A) and the organopolysiloxane described in (B) because the flexible and sufficient effect of improving the compression set can be obtained. It is particularly preferred that the amount of the hydrogen atoms be 1.0 mol or more and 2.0 mols or less.

The organohydrogenpolysiloxane described in (C) can be obtained by a known method. For example, the organohydrogenpolysiloxane described in (C) can be obtained easily by equilibrating a mixture of 1,3,5,7-tetramethyl-1,3,5,7-tetrahydrocyclotetrasiloxane (mixture of the cyclotetrasiloxane and octamethylcyclotetrasiloxane, in some cases) and a siloxane compound to serve as terminal group source such as hexamethyldisiloxane and 1,3-dihydro-1,1,3,3-tetramethyldisiloxane, or a mixture of octamethylcyclotetrasiloxane and 1,3-dihydro-1,1,3,3-tetramethyldisiloxane at a temperature of about −10° C. to +40° C. in the presence of a catalyst such as sulfuric acid, trifluoromethanesulfonic acid, and methanesulfonic acid.

The carbon black described in (D) is carbon black for imparting electro-conductivity to the elastic layer. As the carbon black, those which are generally used for an electro-conductive rubber composition can be used. Examples of the carbon black include acetylene black, furnace black, conductive channel black, and furnace black and channel black that are heat-treated at a high temperature of about 1,500° C. In particular, of those, it is preferred to use carbon black having a low sulfur content because the carbon black does not cause curing inhibition easily. Specific examples of the carbon black having a low sulfur content include: Denka Black powder products (produced by Denki Kagaku Kogyo Kabushiki Kaisha); Asahi #35 and Asahi #65 (produced by Asahi Carbon Co., Ltd.); #750B and MA600 (produced by Mitsubishi Chemical Corporation); and Toka Black #3855, Toka Black #3845, and Toka Black #3800 (produced by Tokai Carbon Co., Ltd.). Herein, from the viewpoint of resistance stability, it is preferred to use a mixture of acetylene black and one or two or more kinds of the above-mentioned carbon blacks except acetylene black.

The added amount of the carbon black described in (D) varies depending on which degree of electro-conductivity is required in the elastic layer of the developing roller of the present invention, and the carbon black described in (D) is generally added in an amount of about 1 to 20 parts by mass with respect to a total of 100 parts by mass of the organopolysiloxane described in (A), the organopolysiloxane described in (B), and the organohydrogenpolysiloxane described in (C).

In order to impart electro-conductivity to the elastic layer, another electro-conductive agent can be used together with the carbon black described in (D), if required. Examples of the electro-conductive agent include various kinds of electro-conductive metals or alloys such as graphite, aluminum, copper, tin, and stainless steel, and metal oxides obtained by subjecting tin oxide, zinc oxide, indium oxide, titanium oxide, or a tin oxide-antimony oxide solid solution to various electro-conducting treatments.

It is preferred that a mixture containing the components described in (A) to (D) contains a catalyst as the (E) component so as to accelerate a curing reaction.

Specifically, the catalyst as used herein is a catalyst for accelerating hydrosilylation addition reactions between the organopolysiloxane described in (A) and the organohydrogenpolysiloxane described in (C), and between the organopolysiloxane described in (B) and the organohydrogenpolysiloxane described in (C).

Specific examples of the catalyst include a platinum-based catalyst, a rhodium-based catalyst, and a palladium-based catalyst. Of those, the platinum-based catalyst is preferred.

Examples of the platinum-based catalyst include platinum-based compounds such as platinum fine powder, platinum black, platinum-supported silica fine powder, platinum-supported activated carbon, chloroplatinic acid, an alcohol solution of chloroplatinic acid, an olefin complex of platinum, and an alkenylsiloxane complex of platinum. The content of the catalyst described in (E) refers to a catalyst amount, and the amount of metallic atoms in the catalyst is generally about 0.5 to 1,000 ppm in terms of a mass unit with respect to a total mass of the organopolysiloxane described in (A), the organopolysiloxane described in (B), and the organohydrogenpolysiloxane described in (C).

In addition to the foregoing, various inorganic fillers may be compounded in the elastic layer according to the preset invention. Examples of the inorganic filler include, but not limited to, inorganic particles such as pulverized quartz, fused quartz powder, diatomaceous earth, pearlite, mica, calcium carbonate, glass flakes, hollow filler, fumed silica, and precipitated silica.

In addition, those inorganic fillers may be subjected to a surface treatment with a silane-based coupling agent or partial hydrolysate thereof, an alkylalkoxysilane or partial hydrolysate thereof, organic silazanes, a titanate-based coupling agent, an organopolysiloxane oil, a hydrolyzable functional group-containing organopolysiloxane, or the like. The inorganic filler itself may be treated by those treatments in advance or at the time of mixing with oil.

Although there is no particular limit to the added amount of the inorganic filler, it is preferred that the added amount be small in order to reduce the compression set of the elastic layer. Specifically, it is preferred that the added amount of the inorganic filler be 20 parts by mass or less with respect to a total of 100 parts by mass of the organopolysiloxane described in (A), the organopolysiloxane described in (B), and the organohydrogenpolysiloxane described in (C), and it is particularly preferred that the inorganic filler be not compounded.

The mixture according to the present invention may contain various additives in a range not impairing the object of the present invention, in addition to the above-mentioned (A) to (E).

In order to adjust the curing rate of the mixture, there may be contained in the mixture, for example, an alkyne alcohol such as 2-methyl-3-butyn-2-ol, 3,5-dimethyl-1-hexyne-3-ol, 1-ethynyl-1-cyclohexanol, and phenylbutynol; an enyne compound such as 3-methyl-3-pentene-1-yne and 3,5-dimethyl-3-hexene-1-yne; or a reaction inhibitor such as 1,3,5,7-tetramethyl-1,3,5,7-tetravinylcyclotetrasiloxane, 1,3,5,7-tetramethyl-1,3,5,7-tetrahexenylcyclotetrasiloxane, and benzotriazole.

Further, there may be mixed in the mixture, a dispersant such as diphenylsilanediol, a heat resistance improver such as iron oxide, cerium oxide, and iron octylate, various carbon functional silanes for improving adhesion or molding processability, a halogen compound for imparting flame retardancy, or the like.

There is no particular limit to a method of mixing the above-mentioned (A) to (E), the inorganic fillers, and additives, and a known mixer such as a planetary mixer, a kneader, and a roll can be used.

As a method of forming the elastic layer according to the present invention on a mandrel, a known method can be used. Specifically, for example, the mixture containing the above-mentioned (A) to (E) is liquid, and hence, a method involving injecting the mixture containing the above-mentioned (A) to (E) into a mold having a cylindrical pipe and pieces for holding a mandrel provided at both ends of the pipe, and heat-curing the mixture is preferred. The heating condition for curing the mixture can be selected according to a curing rate of the mixture.

Further, in order to complete the removal of low-molecular components contained in the mixture and the reaction of the mixture, the mixture can be further heated after being cured by heating once. It is preferred that the heating be performed under the condition of 170° C. to 230° C. for 30 minutes to 8 hours.

As the substrate, any substrate that can function as an electrode for an electro-conductive member, and a member for supporting an elastic layer or a coating layer can be applied to the present invention. A material for the substrate is formed of a metal or an alloy such as aluminum, copper, stainless steel, and iron, or an electro-conductive material such as an electro-conductive synthetic resin. Those materials may be plated with chromium or nickel. In order to adhere to the substrate and the elastic layer formed on the surface of the substrate to each other, the surface of the substrate can be coated with a primer. An example of a primer used generally is a silane coupling-based primer.

The developing member according to the present invention includes the coating layer on the elastic layer. The resin to be used as the coating layer is not particularly limited. Specific examples thereof include a fluororesin, a polyamide resin, an acrylic urethane resin, a phenol resin, a melamine resin, a silicone resin, a urethane resin, a polyester resin, a polyvinyl acetal resin, an epoxy resin, a polyether resin, an amino resin, an acrylic resin, a urea resin, and a mixture thereof. Of those, a urethane resin is preferred in consideration of, for example, charge-providing performance for the toner.

A resin to which a resistance adjusting agent has been added may be used as the coating layer. Examples of the resistance adjusting agent include: an electro-conductive carbon black such as acetylene black; a carbon black for rubber such as SAF, ISAF, HAF, FEF, GPF, SRF, FT, and MT; a carbon black for color (ink) to be subjected to an oxidation treatment or the like; and an electro-conductive powder of a metal such as copper, silver, and germanium and a metal oxide. Besides, as an ionic conductive substance used as the resistance adjusting agent, there may be used, for example, inorganic ionic conductive substances such as sodium perchlorate, lithium perchlorate, calcium perchlorate, and lithium chloride, and organic ionic conductive substances such as modified aliphatic dimethylammonium ethosulfate and stearylammonium acetate. The carbon black is preferred because the carbon black can control conductivity with a small addition amount. The compounding amount of the carbon black is preferably 3 parts by mass or more and 30 parts by mass or less with respect to 100 parts by mass of the resin component.

Further, roughness imparting particles for controlling the surface roughness of the developing member can be added to the coating layer. There is no particular limit to the kind of roughness imparting particles, but resin particles such as acrylic resin particles, silicone resin particles, urethane resin particles, and phenol resin particles are preferred.

As a method of forming a coating layer on an elastic layer, a known method can be used without any particular limit. From the viewpoint of obtaining a stable surface shape, a method involving coating the surface of an elastic layer with coating material for coating layer with an immersion coating machine illustrated in FIG. 3 is preferred. In FIG. 3, a cylindrical immersion tank 20 has an inner diameter larger than an outer shape of an elastic member and a depth larger than an axial direction length of the elastic member. On an upper outer circumferential edge of the immersion tank 20, a circular liquid receiving portion is provided, and the liquid receiving portion is connected to a stirring tank 21. Further, a bottom portion of the immersion tank 20 is connected to the stirring tank 21, and a coating material in the stirring tank 21 is fed to the bottom portion of the immersion tank 20 by a liquid feeding pump 22. The coating material fed to the bottom portion of the immersion tank 20 overflows an upper end portion of the immersion tank to return to the stirring tank 21 through the liquid receiving portion on the upper outer circumferential edge of the immersion tank 20. An elastic roller member including the elastic layer 2 provided on the mandrel 1 is fixed perpendicularly to a lifting and lowering device 23 and is immersed into the coating material for coating layer in the immersion tank 20 and then lifted, whereby the coating layer 3 is formed.

There is no particular limit to a method of dispersing the resistance adjusting agent and the roughness imparting particles into the coating material for forming a coating layer. For example, the resistance adjusting agent, the roughness imparting particles, or the like can be added to a resin solution obtained by dissolving a resin material into an appropriate organic solvent, and can be dispersed through use of a known device such as a sand grinder, a sand mill, and a ball mill.

It is preferred that the thickness of the coating layer be 4 μm or more and 50 μm or less, in particular, 5 μm or more and 45 μm or less. By setting the thickness of the coating layer in the above-mentioned range, breeding of low-molecular components in the elastic layer to the surface of the developing member can be controlled more reliably.

FIG. 2 is a cross-sectional view illustrating an example of a schematic configuration of an electrophotographic image forming apparatus including a developing member according to the present invention. The image forming apparatus of FIG. 2 includes a developing unit 9 having a developing roller 4, a toner supplying roller 6, toner 7, and a developing blade 8 according to the present invention. Further, the image forming apparatus includes a photosensitive drum 5, a cleaning blade 13, a waste toner container 12, and a charging unit 11. The photosensitive drum 5 rotates in an arrow direction. As a result, the surface of the photosensitive drum 5 is uniformly charged by the charging member 11 for charging the photosensitive drum 5, and an electrostatic latent image is formed on the surface of the photosensitive drum 5 with laser light 10 of the exposing unit for writing the electrostatic latent image on the photosensitive drum 5. The electrostatic latent image is supplied with toner by the developing roller 4 arranged in contact with the photosensitive drum 5, and thereby, developed and visualized as a toner image.

As the development, so-called reversal development is performed in which a negatively chargeable toner image is formed on an exposure portion. The visualized toner image on the photosensitive drum 5 is transferred onto an intermediate transfer belt 14 by a primary transfer roller 15. The toner image on the intermediate transfer belt is transferred onto a sheet 18 fed from a sheet feeding roller 17 by a secondary transfer roller 16. The sheet 18 with the toner image transferred thereon is subjected to fixing treatment by a fixing unit and delivered out of the apparatus, whereby a print operation is completed.

Meanwhile, transfer residual toner remaining on the photosensitive drum 5 without being transferred is scraped off with the cleaning blade 13 for cleaning the surface of the photosensitive drum, and the cleaned photosensitive drum 5 repeats the above-mentioned operation.

The developing unit 9 includes a developing container containing the toner 7 and the developing roller that is positioned in an opening extending in a longitudinal direction in the developing container and is opposed to the photosensitive drum 5. The unit develops an electrostatic latent image on the photosensitive drum 5 to visualize the latent image.

The developing process in the developing unit 9 is described below. The surface of the developing roller 4 is coated with toner by the toner supplying roller 6 supported rotatably. The toner, with which the surface of the developing roller 4 is coated, rubs against the developing blade 8 as a result of the rotation of the developing roller 4. The developing roller 4 is in contact with the photosensitive drum 5 while rotating and develops the electrostatic latent image formed on the photosensitive drum 5 with the toner, with which the surface of the developing roller 4 is coated, to form an image.

As the structure of the toner supplying roller 6, a foamed skeletal spongy structure or a fur brush structure in which fibers such as rayon and polyamide are implanted on a mandrel is preferred from the viewpoints of the supplying of the toner 7 to the developing roller 4 and the scraping of undeveloped toner. For example, an elastic roller in which polyurethane foam is provided on a mandrel can be used.

The contact width of the toner coating member 6 with respect to the developing roller 4 is preferably 1 to 8 mm, and further, it is preferred that the toner coating member 6 allow the developing roller 4 to have a relative speed in its contact portion.

### EXAMPLES

The developing roller of the present invention is hereinafter described specifically in detail, but the technical scope of the present invention is not limited by the following description.

### Example 1

### Production of an Elastic Roller 1

The surface of a mandrel with a diameter of 6 mm in which the surface of iron was plated with nickel was coated with a primer (trade name: DY35-051, produced by Dow Corning Toray Co., Ltd.), and thereafter, the primer was baked at a temperature of 170° C. for 20 minutes. Then, the mandrel was incorporated into a mold having a cylindrical pipe with an inner diameter of 12 mm and pieces for holding the mandrel provided at both ends of the pipe, and a liquid material for forming an elastic layer prepared from materials in the following Table 1 was injected from the piece at one end and then heated at 130° C. for 20 minutes. After cooling, the resultant was removed from the mold to obtain a primary cured elastic roller in which an elastic layer having a thickness of 3.0 mm was provided on the periphery of the mandrel. Further, the roller was heated in an oven at 200° C. for 2 hours to obtain an elastic roller 1.

TABLE 1
(Materials constituting liquid material
for forming elastic layer)

| | Part(s) by |
|---|---|
| | mass |
| (A1) Both-terminals-dimethylvinylsiloxy- | 100 |
| dimethylpolysiloxane (viscosity at 25° C.: 50 | |
| Pa · s) | |
| (B1) Organopolysiloxane which includes | 6 |
| constituent units of CH₂═CH(CH₃)₂SiO_{1/2} unit, | |
| (CH₃)₃SiO_{1/2} unit, and SiO_{4/2} unit as constituent | |
| units, has a molar ratio of the total amount | |
| of the CH₂═CH(CH₃)₂SiO_{1/2} unit and the | |
| (CH₃)₃SiO_{1/2} unit to the SiO_{4/2} unit of 1.0, has | |
| a weight-average molecular weight of 3,700, | |
| and has an average of 4 vinyl groups bonded to | |
| a silicon atom in one molecule | |
| (C1) Organohydrogenpolysiloxane which is a | 5 |
| both-terminals-trimethylsiloxy-methylhydrogen | |
| siloxane-dimethylsiloxane copolymer, has a | |
| weight-average molecular weight of 2,000, and | |
| has an average of 9.2 hydrogen atoms bonded to | |
| a silicon atom in one molecule | |
| (D1) Carbon black (trade name: Denka Black | 2 |
| powdered product produced by Denki Kagaku | |
| Kogyo Kabushiki Kaisha.) | |
| (D2) Carbon black (trade name: SUNBLACK235 | 4 |
| produced by Asahi Carbon Co., Ltd.) | |
| (E1) Platinum catalyst (Pt concentration: 1%) | 0.1 |

### Production of a Coating Material for Coating Layer 1

Materials in the following combination were mixed to perform pre-mixing through use of DISPER. After that, the mixture was dispersed with a sand mill using glass beads each having a particle diameter of 1.5 mm for 4 hours to obtain a coating material for coating layer 1.
Polyol (trade name: NIPPOLLAN 5120, produced by NIPPON POLYURETHANE INDUSTRY CO., LTD.): 87 parts by mass
Isocyanate (trade name: CORONATE L-55E, produced by NIPPON POLYURETHANE INDUSTRY CO., LTD.): 13 parts by mass
Carbon black (trade name: MA 100, produced by Mitsubishi Chemical Corporation): 8 parts by mass
Urethane resin particles (trade name: Art Pearl C-600 transparent, produced by Negami Chemical Industrial Co., Ltd.): 10 parts by mass
Methyl ethyl ketone (MEK): amount so that the solid content of coating material is 35 mass %

### Formation of a Coating Layer on an Elastic Layer

The surface of the elastic layer of the elastic roller 1 was subjected to immersion coating with the coating material for coating layer 1 obtained as described above through use of an overflow-type immersion coating machine illustrated in FIG. 3. After that, the coating material for coating layer 1 was dried with air at room temperature for 30 minutes and then heat-treated with a hot air circulation oven at 140° C. for 2 hours. Thus, a developing roller 1 having a coating layer with a thickness of 12 μm on the surface of the elastic layer was obtained. The obtained developing roller was measured and evaluated as described below. Table 2 shows the results.

<Measurement of a Surface Roughness (Ra)>

A surface roughness Ra was measured through use of a contact-type surface roughness tester Surfcom 480A (produced by Tokyo Seimitsu Co., Ltd.) according to JIS B 0601:1994 surface roughness standard. Specifically, the measurement was performed through use of a sensing pin with a radius of 2 μm under the following conditions: a pressing force of 0.7 mN, a measurement rate of 0.3 mm/sec, a measurement magnification of 5,000-power, a cutoff wavelength of 0.8 mm, and a measurement length of 2.5 mm. This measurement was performed with respect to nine points in total including three points in each of the circumferential directions of three points in an axial direction of the developing roller, and an average value thereof was defined as a surface roughness Ra.

<Measurement of Asker C Hardness>

Asker C hardness was measured in a 23° C., 55% RH environment through use of an Asker C spring-type rubber hardness meter (produced by Kobunshi Keiki Co. Ltd.) according to the standard of measure SRIS0101 of THE SOCIETY OF RUBBER SCIENCE AND TECHNOLOGY, JAPAN. The above-mentioned hardness meter was brought into contact with the developing roller, which was left in a 23° C., 55% RH environment for 12 hours or more, under a force of 10 N, and a value obtained 30 seconds later was defined as a measured value. The measurement was performed with respect to 12 points in total positioned at each angle of 90° in the circumferential direction from three points: a center portion in the axial direction of the elastic layer and points of 30 mm each from both end portions of the elastic layer to the longitudinal center portion. An arithmetic average of the measured values was defined as Asker C hardness.

<Measurement of an Electric Resistance>

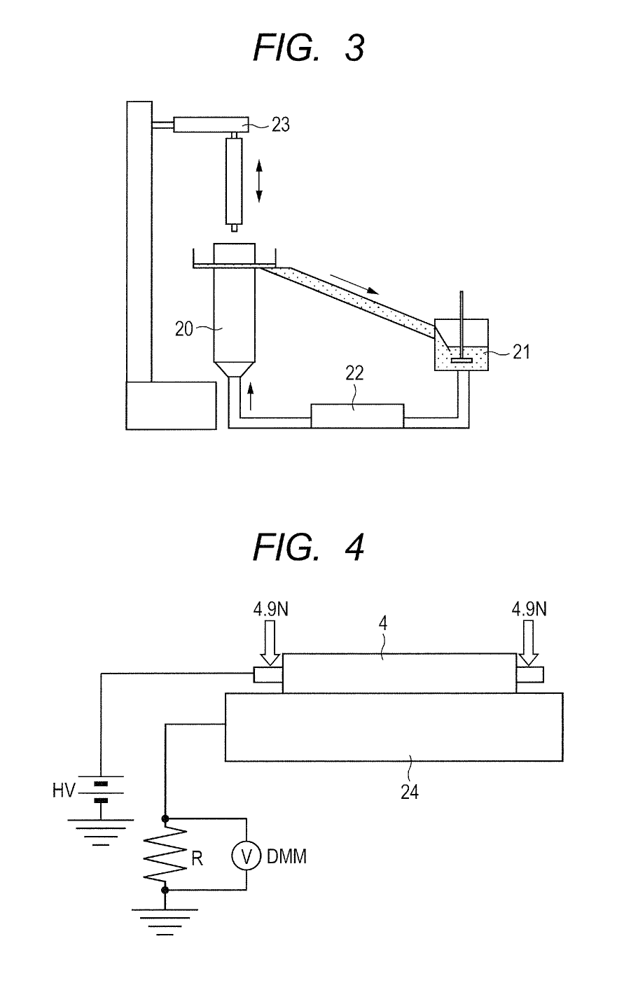

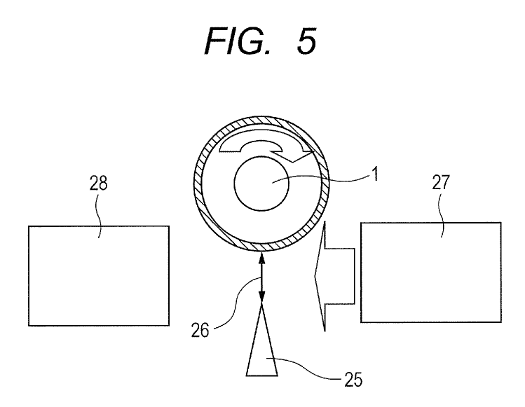

An electric resistance was measured through use of an electric resistance measurement device illustrated in FIG. 4. The developing roller 4 was brought into contact with a metal drum 24 having a diameter of 50 mm under the application of a load of 4.9 N to each of both ends of a mandrel. The metal drum 24 was rotated at a surface velocity of 50 mm/sec, and the developing roller 4 was driven to rotate. A resistor R having a known electric resistance that was lower by two or more digits than the electric resistance of the developing roller was connected between the metal drum 24 and the ground.

A voltage of +50 V was applied from a high-voltage power source HV to the mandrel of the developing roller, and an electrical potential difference between both ends of the resistor R was measured through use of a digital multimeter DMM (for example, 189 TRUE RMS MULTIMETER, produced by Fluke Corporation). A current having flowed to the metal drum through the developing roller was calculated from the measured value of the electrical potential difference and the electric resistance of the resistor R, and an electric resistance of the developing roller was calculated from the current and the applied voltage of 50 V. In the measurement using the digital multimeter, sampling was performed for 3 seconds after the elapse of 2 seconds from the application of the voltage, and a value calculated from an average value thereof was defined as a resistance of the developing roller.

<Measurement of a Compression Set Amount>

The outer diameter size of the obtained developing roller was measured through use of such a device as illustrated in FIG. 5. The measurement device includes a dimension measurement machine (trade name: LS-7000, produced by Keyence Corporation) having: an electro-conductive mandrel receiver (not shown) that rotates about the electro-conductive mandrel; an encoder (not shown) for detecting the rotation of the electro-conductive mandrel; a reference plate 25; a laser light emitting portion 27; and a laser light receiving portion 28. By measuring a gap amount 26 between the surface of the developing roller and the reference plate while rotating the developing roller, the outer diameter of the developing roller was calculated. Note that, the gap amount between the surface of the developing roller and the reference plate was measured with respect to three points in total: a longitudinal center portion of the elastic layer and points of 20 mm each from both end portions of the elastic layer to the longitudinal center portion. Measurement was performed at 360 points at a pitch of 1° with respect to one turn of the developing roller. The measurement was performed in a 23° C., 55% RH environment through use of the developing roller left in a 23° C., 55% RH environment for 6 hours or more.

The developing roller whose outer diameter shape was measured in advance as described above was incorporated into a black cartridge for a printer LBP7700C produced by Canon Inc. (trade name: Toner Cartridge 32311 (black), produced by Canon Inc.). Note that, the contact pressure between the developing roller and the developing blade in the cartridge was changed to 0.5 N/cm that was disadvantageous effect on the occurrence of compression set. After the cartridge was left in a 40° C., 95% RH environment for 30 days, the developing roller was taken out to a 23° C., 55% RH environment, and then the outer diameter shape of the developing roller after being left in a 23° C., 55% RH environment for 6 hours was measured in a 23° C., 55% RH environment. The measurement of the outer diameter shape was performed with respect to the same position as that before the cartridge was left in the 40° C., 95% RH environment to obtain a change in outer diameter size of the developing roller before and after being left at the contact position with the developing blade, and a maximum value of the change amount was defined as a compression set amount.

<Image Output Test>

The above-mentioned developing roller in which a compression set amount was measured was incorporated into a black cartridge (trade name: Toner Cartridge 32311 (black), produced by Canon Inc.) dedicated for a laser printer (trade name: LBP7700C, produced by Canon Inc.), and thereby, a cartridge for an image output test was produced.

The cartridge for an image output test thus produced was incorporated into a printer LBP7700C produced by Canon Inc., and an image output test was performed. A half-tone image was output and ranked as described below. Note that, a period of time from the measurement of a compression set amount to the image output was set to be one hour. Table 2 shows the results.

A: A uniform image is obtained.
B: Density unevenness caused by the deformation of the developing roller is observed very slightly.
C: Density unevenness caused by the deformation of the developing roller is observed slightly.
D: Density unevenness caused by the deformation of the developing roller is observed remarkably.

<Wear Evaluation of Photosensitive Drum>

The above-mentioned cartridge for an image output test was incorporated into a laser printer (trade name: LBP7700C, produced by Canon Inc.), and a continuous image output test was performed.

Note that, the movement rate of the surface of the developing roller with respect to the movement rate of the surface of the photosensitive drum was changed to 180%, and thus, changed to disadvantageous setting for wear of the photosensitive drum. After 40,000 images whose printing ratio was 1% were output, a region in which the developing roller came into contact with the photosensitive drum was observed visually. Further, the presence or absence of a charging bias leak image was checked during the continuous image output test and the test was ranked as described below. Table 2 shows the results.

A: Wear of the surface of the photosensitive drum including end portions thereof is not observed, and a charging bias leak image does not occur.
B: Although very slight wear is observed at end portions of the photosensitive drum, a charging bias leak image does not occur.
C: Although wear is observed at end portions of the photosensitive drum, a charging bias leak image does not occur.
D: Wear is observed at end portions of the photosensitive drum, and a charging bias leak image occurs.

### Example 2

A developing roller 2 was produced in the same way as in Example 1, except for further adding, in Example 1, 1.5 parts by mass of hydrophobic silica (trade name: RX200, produced by Nippon Aerosil Co., Ltd.) to a materials constituting the liquid material for forming an elastic layer of Example 1, and was measured and evaluated in the same way as in Example 1. Table 2 shows the results.

### Example 3

A developing roller 3 was produced in the same way as in Example 2, except for using the following (B2) in place of the (B1) in Example 2, and was measured and evaluated in the same way as in Example 1. Table 2 shows the results.

(B2): Organopolysiloxane which includes constituent units of CH₂—CH(CH₃)₂SiO_{1/2} unit, (CH₃)₃SiO_{1/2} unit, and SiO_{4/2} unit, has a molar ratio of the total amount of the CH₂—CH(CH₃)₂SiO_{1/2} unit and the (CH₃)₃SiO_{1/2} unit to the SiO_{4/2} unit of 0.5, has a weight-average molecular weight of 6,600, and has an average of 4 vinyl groups bonded to a silicon atom in one molecule.

### Example 4

A developing roller 4 was produced in the same way as in Example 2, except for using the following (B3) in place of the (B1) in Example 2, and was measured and evaluated in the same way as in Example 1. Table 2 shows the results.

(B3): Organopolysiloxane which includes constituent units of CH₂—CH(CH₃)₂SiO_{1/2} unit, (CH₃)₃SiO_{1/2} unit, and SiO_{4/2} unit, has a molar ratio of the total amount of the CH₂—CH(CH₃)₂SiO_{1/2} unit and the (CH₃)₃SiO_{1/2} unit to the SiO_{4/2} unit of 2.0, has a weight-average molecular weight of 2,100, and has an average of 4 vinyl groups bonded to a silicon atom in one molecule.

### Example 5

A developing roller 5 was produced in the same way as in Example 2, except for changing the compounding amount of the (B1) to 2 parts by mass in Example 2, and was measured and evaluated in the same way as in Example 1. Table 2 shows the results.

### Example 6

A developing roller 6 was produced in the same way as in Example 2, except for changing the compounding amount of the (B1) to 10 parts by mass in Example 2, and was measured and evaluated in the same way as in Example 1. Table 2 shows the results.

### Example 7

A developing roller 7 was produced in the same way as in Example 2, except for using the following (A2) in place of the (A1) and changing the compounding amount of the (C1) to 8 parts by mass in Example 2, and was measured and evaluated in the same way as in Example 1. Table 2 shows the results.

(A2) Both-terminals-dimethylvinylsiloxy-dimethylpolysiloxane (viscosity at 25° C.: 10 Pa·s)

### Example 8

A developing roller 8 was produced in the same way as in Example 2, except for using the following (A3) in place of the (A1) and changing the compounding amount of the (C1) to parts by mass in Example 2, and was measured and evaluated in the same way as in Example 1. Table 2 shows the results.

(A3) Both-terminals-dimethylvinylsiloxy-dimethylpolysiloxane (viscosity at 25° C.: 100 Pa·s)

### Example 9

A developing roller 9 was produced in the same way as in Example 7, except for using the following (B4) in place of the (B1) and changing the compounding amount of the (B4) to parts by mass in Example 7, and was measured and evaluated in the same way as in Example 1. Table 2 shows the results.

(B4): Organopolysiloxane which includes constituent units of CH₂═CH(CH₃)₂SiO_{1/2} unit, (CH₃)₃SiO_{1/2} unit, and SiO_{4/2} unit, has a molar ratio of the total amount of the CH₂═CH(CH₃)₂SiO_{1/2} unit and the (CH₃)₃SiO_{1/2} unit to the SiO_{4/2} unit of 0.4, has a weight-average molecular weight of 8,000, and has an average of 4 vinyl groups bonded to a silicon atom in one molecule.

### Example 10

A developing roller 10 was produced in the same way as in Example 8, except for using the following (B5) in place of the (B1) and changing the compounding amount of the (B5) to 1 part by mass in Example 8, and was measured and evaluated in the same way as in Example 1. Table 2 shows the results.

(B5): Organopolysiloxane which includes constituent units of CH₂═CH(CH₃)₂SiO_{1/2} unit, (CH₃)₃SiO_{1/2} unit, and SiO_{4/2} unit, has a molar ratio of the total amount of the CH₂═CH(CH₃)₂SiO_{1/2} unit and the (CH₃)₃SiO_{1/2} unit to the SiO_{4/2} unit of 2.2, has a weight-average molecular weight of 1,900, and has an average of 4 vinyl groups bonded to a silicon atom in one molecule.

### Comparative Example 1

A developing roller 11 was produced in the same way as in Example 2, except that the (B1) was not compounded in Example 2, and was measured and evaluated in the same way as in Example 1. Table 2 shows the results.

### Comparative Example 2

A developing roller 12 was produced in the same way as in Example 2, except for using the following (A4) in place of the (A1) and changing the compounding amount of the (C1) to 10 parts by mass in Example 2, and was measured and evaluated in the same way as in Example 1. Table 2 shows the results.

(A4) Both-terminals-dimethylvinylsiloxy-dimethylpolysiloxane (viscosity at 25° C.: 7 Pa·s)

### Comparative Example 3

A developing roller 13 was produced in the same way as in Example 2, except for using the following (A5) in place of the (A1) and changing the compounding amount of the (C1) to 2 parts by mass in Example 2, and was measured and evaluated in the same way as in Example 1. Table 2 shows the results.

(A5) Both-terminals-dimethylvinylsiloxy-dimethylpolysiloxane (viscosity at 25° C.: 120 Pa·s)

### Comparative Example 4

A developing roller 14 was produced in the same way as in Example 2, except for using the following siloxane compound having oil segment in place of the (B1) in Example 2, and was measured and evaluated in the same way as in Example 1. Table 2 shows the results.

Organopolysiloxane which includes constituent units of CH₂═CH(CH₃)₂SiO_{1/2} unit, (CH₃)₃SiO_{1/2} unit, (CH₃)₂SiO_{2/2} unit, and SiO_{4/2} unit, has a molar ratio of the total amount of the CH₂═CH(CH₃)₂SiO_{1/2} unit, the (CH₃)₃SiO_{1/2}, and (CH₃)₂SiO_{2/2} unit to the SiO_{4/2} unit of 1.0, has a weight-average molecular weight of 4,000, and has an average of 4 vinyl groups bonded to a silicon atom in one molecule

TABLE 2

| | | | | Filler | | | | | Image | |
|---|---|---|---|---|---|---|---|---|---|---|
| | (A) | (B) | | kind/amount | Surface | | Asker c | Compression | caused by | Wear of |
| | Viscosity | | Compounding | (part(s) by | roughness | Resistance | hardness | set amount | compression | photosensitive |
| | [Pa · s] | M/Q*¹ | amount | mass) | Ra | [Ω] | [degree] | [μm] | set | drum |
| Example 1 | 50 | 1.0 | 6 | — | 1.8 | 5 × 10⁴ | 55 | 1.3 | A | A |
| Example 2 | | | | Hydrophobic | | | 56 | 1.8 | A | A |
| Example 3 | | 0.5 | | silica | | | 57 | 1.5 | A | A |
| Example 4 | | 2.0 | | 1.5 | | | 54 | 2.1 | A | A |
| Example 5 | | 1.0 | 2 | | | | 55 | 2.0 | A | A |
| Example 6 | | | 10 | | | | 58 | 1.4 | A | A |
| Example 7 | 10 | | 6 | | | | 60 | 1.2 | A | B |
| Example 8 | 100 | | | | | | 52 | 2.5 | B | A |
| Example 9 | 10 | 0.4 | 12 | | | | 61 | 1.1 | A | C |
| Example 10 | 100 | 2.2 | 1 | | | | 51 | 2.7 | C | A |
| Comparative | 50 | — | — | | | | 53 | 4.8 | D | A |
| Example 1 | | | | | | | | | | |
| Comparative | 7 | 1.0 | 6 | | | | 65 | 1.0 | A | D |
| Example 2 | | | | | | | | | | |
| Comparative | 120 | | | | | | 51 | 4.2 | D | A |
| Example 3 | | | | | | | | | | |
| Comparative | 50 | 1.0*² | 6*² | | | | 55 | 4.1 | D | A |
| Example 4 | | | | | | | | | | |

In Table 2,
*¹represents a molar ratio (M/Q) of the R¹R²R³SiO_{1/2} unit to the SiO_{4/2} unit.
*²represents the case where a siloxane compound including R¹R²SiO_{2/2} that is oil segment, and the SiO_{4/2} unit and the R¹R²R³SiO_{1/2} unit is compounded.

As is apparent from Table 2, in the developing roller according to the present invention, the occurrence of compression set when the developing roller and the developing blade are left in contact with each other for a long period of time can be controlled. Thus, an image defect caused by the compression set was able to be alleviated. At the same time, in the developing roller of the present invention, the wear of the photosensitive drum was able to be suppressed.

Comparative Example 1 does not contain the organopolysiloxane described in the (B) that is an essential component of the present invention. It is considered that, because of this, compression set became large and an image defect caused by the compression set occurred.

In Comparative Example 2, the viscosity of the organopolysiloxane described in the (A) is too small, that is, the molecular weight thereof is too small, and hence, the hardness of the developing roller is high. It is considered that, because of this, the wear of the photosensitive drum proceeded remarkably, and a charging bias leak image was generated.

In Comparative Example 3, the viscosity of the organopolysiloxane described in the (A) is too large, that is, the molecular weight thereof is too large, and hence, a molecular weight between cross-linking points is large. It is considered that, because of this, a compression set amount became large and an image defect caused by the compression set occurred.

In Comparative Example 4, a siloxane compound including the R¹R²SiO_{2/2} unit that is oil segment, and the SiO_{4/2} unit and the R¹R²R³SiO_{1/2} unit is compounded in place of the organopolysiloxane described in the (B). It is considered that, the siloxane compound had the oil segment, and hence, the degree of freedom of molecular structure increased and compression set could not be controlled. On the other hand, in Examples 1 to 10, it is considered that, by compounding the organopolysiloxane described in the (B) including constituent units of the SiO_{4/2} unit and the R¹R²R³SiO_{1/2} unit, the occurrence of compression set was able to be controlled effectively.

As described above, it is apparent that, by satisfying the configuration defined in the present invention, the wear of the photosensitive drum is small by virtue of its flexibility, and the developing member can be obtained in which compression set does not occur easily even when left in contact with the developing blade for a long period of time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2011-183826, filed on Aug. 25, 2011, the entire disclosure of which is incorporated herein by reference.

1. A developing member, comprising:
a substrate;
an elastic layer provided on the substrate; and
a coating layer provided on the elastic layer,
wherein the elastic layer contains a cured substance of a mixture containing the following (A) to (D):
(A) organopolysiloxane having two or more vinyl groups bonded to a silicon atom in one molecule and having a viscosity at 25° C. of 10 Pa·s or more and 100 Pa·s or less;
(B) organopolysiloxane including constituent units of SiO_{4/2} unit and R¹R²R³SiO_{1/2} unit, where R¹, R², and R³ each represent one of a methyl group and a vinyl group, and having two or more vinyl groups bonded to a silicon atom in one molecule;
(C) organohydrogenpolysiloxane having two or more hydrogen atoms bonded to a silicon atom in one molecule; and
(D) carbon black.

2. The developing member according to claim 1, wherein the (A) comprises organopolysiloxane represented by the following average composition formula (1):
RₐSiO_{(4-a)/2} (1)
in the formula (1), R represents a monovalent hydrocarbon group having 1 to 10 carbon atoms, and a represents a positive number in a range of 1.5 to 2.8.

3. The developing member according to claim 2, wherein the a represents a positive number in a range of 1.8 to 2.5.

4. The developing member according to claim 1, wherein the (B) comprises organopolysiloxane represented by the following average composition formula (2) and having two or more vinyl groups bonded to a silicon atom in one molecule:
(R¹R²R³SiO_{1/2})ₓ(SiO_{4/2})_{1.0} (2)
in the formula (2), R¹, R², and R³ each independently represent one of a methyl group and a vinyl group, and X represents a positive number that is larger than 0 and smaller than 4.0.

5. The developing member according to claim 4, wherein, in the (B), a molar ratio of the R¹R²R³SiO_{1/2} unit to the SiO_{4/2} unit is 0.5 or more and 2.0 or less.

6. The developing member according to claim 1, wherein the (B) is 2 parts by mass or more and 10 parts by mass or less with respect to 100 parts by mass of the (A).

7. (canceled)

8. The developing member according to claim 1, wherein the coating layer contains urethane resin.

9. A method of producing a developing member comprising:
a substrate;
an elastic layer provided on the substrate; and
a coating layer provided on the elastic layer,
the method comprising a step of curing a mixture containing the following (A) to (D) to form the elastic layer:
(A) organopolysiloxane having two or more vinyl groups bonded to a silicon atom in one molecule and having a viscosity at 25° C. of 10 Pa·s or more and 100 Pa·s or less;
(B) organopolysiloxane including constituent units of SiO_{4/2} unit and R¹R²R³SiO_{1/2} unit, where R¹, R², and R³ each represent one of a methyl group and a vinyl group, and having two or more vinyl groups bonded to a silicon atom in one molecule;
(C) organohydrogenpolysiloxane having two or more hydrogen atoms bonded to a silicon atom in one molecule; and
(D) carbon black.

10. An image forming apparatus, comprising:
a photosensitive drum; and
a developing unit for developing an electrostatic latent image formed on a surface of the photosensitive drum with toner,
wherein the developing unit comprises a developing roller arranged in contact with the photosensitive drum, and
the developing roller comprises the developing member according to claim 1.
